(19) United States
(12) Patent Application Publication
(10) Pub. No.: US 2024/0292475 A1
(43) Pub. Date: Aug. 29, 2024

(54) INFORMATION PROCESSING DEVICE, STORAGE MEDIUM, AND SYSTEM

(71) Applicant: TOYOTA JIDOSHA KABUSHIKI KAISHA, Toyota-shi (JP)

(72) Inventor: Kentaro ASAI, Okazaki-shi (JP)

(73) Assignee: TOYOTA JIDOSHA KABUSHIKI KAISHA, Toyota-shi (JP)

(21) Appl. No.: 18/439,007

(22) Filed: Feb. 12, 2024

(30) Foreign Application Priority Data
Feb. 28, 2023 (JP) 2023-030485

(51) Int. Cl. H04W 76/14; H04L 5/00; H04W 76/15; H04W 88/04

(52) U.S. Cl. CPC H04W 76/14; H04L 5/0048; H04W 76/15; H04W 88/04

(57) ABSTRACT

An information processing device includes a processor that, based on vehicle information on each of vehicles parked within a specific area, decides on an access-point vehicle to execute an access point mode for providing an access point in a vehicle network including the vehicles. The vehicle information includes position information and information related to a range of vehicle-to-vehicle communication, with respect to each vehicle. The processor decides on the access-point vehicle in such a manner that the specific area is covered by the range of vehicle-to-vehicle communication by the access-point vehicle. Among the vehicles parked within the specific area, the processor decides on a gateway vehicle to execute a gateway mode for connecting the first vehicle network to a second vehicle network. The processor transmits instructions about the access point mode and the gateway mode to the access-point vehicle and the gateway vehicle, respectively.

### CROSS-REFERENCE TO RELATED APPLICATION

This application claims priority to Japanese Patent Application No. 2023-030485 filed on Feb. 28, 2023, incorporated herein by reference in its entirety.

### BACKGROUND

### 1. Technical Field

The present disclosure relates to an information processing device, a storage medium, and a system.

### 2. Description of Related Art

There has been known a technique of using a parked vehicle for an access point of a network (for example, Japanese Unexamined Patent Application Publication (Translation of PCT application) No. 2021-509232).

### SUMMARY

The present disclosure provides an information processing device that forms a more appropriate vehicle network.

According to one aspect of the present disclosure, an information processing device includes a processor configured to decide on one or more access-point vehicles to execute an access point mode, based on vehicle information on each of vehicles parked within a specific area, the access point mode being for providing an access point in a first vehicle network including the vehicles. The vehicle information includes position information and information related to a range of vehicle-to-vehicle communication, with respect to each vehicle. The processor is configured to decide on the one or more access-point vehicles such that the specific area is covered by the range or ranges of the vehicle-to-vehicle communication by the one or more access-point vehicles. The processor is configured to decide on one or more gateway vehicles to execute a gateway mode among the vehicles parked within the specific area, the gateway mode being for connecting the first vehicle network to a second vehicle network. The processor is configured to transmit instructions about the access point mode and the gateway mode to the one or more access-point vehicles and the one or more gateway vehicles, respectively.

According to another aspect of the present disclosure, a non-transitory storage medium stores instructions that are executable by one or more processors and that cause the one or more processors to perform functions including: deciding on one or more access-point vehicles to execute an access point mode, based on vehicle information on each of vehicles parked within a specific area, the access point mode being for providing an access point in a first vehicle network including the vehicles. The vehicle information includes position information and information related to a range of vehicle-to-vehicle communication, with respect to each vehicle. The functions include deciding on the one or more access-point vehicles such that the specific area is covered by the range or ranges of the vehicle-to-vehicle communication by the one or more access-point vehicles. The functions include deciding on one or more gateway vehicles to execute a gateway mode among the vehicles parked within the specific area, the gateway mode being for connecting the first vehicle network to a second vehicle network. The functions include transmitting instructions about the access point mode and the gateway mode to the one or more access-point vehicles and the one or more gateway vehicles, respectively.

According to another aspect of the present disclosure, a system includes: vehicles parked within a specific area; and a server including a processor. The processor is configured to decide on one or more access-point vehicles to execute an access point mode, based on vehicle information received from each of the vehicles, the access point mode being for providing an access point in a first vehicle network including the vehicles. The vehicle information includes position information and information related to a range of vehicle-to-vehicle communication, with respect to each vehicle. The processor is configured to decide on the one or more access-point vehicles such that the specific area is covered by the range or ranges of the vehicle-to-vehicle communication by the one or more access-point vehicles. The processor is configured to decide on one or more gateway vehicles to execute a gateway mode among vehicles parked within the specific area, the gateway mode being for connecting the first vehicle network to a second vehicle network. The processor is configured to transmit instructions about the access point mode and the gateway mode to the one or more access-point vehicles and the one or more gateway vehicles, respectively.

Other aspects of the present disclosure include an information processing method in which a computer executes the process in the information processing device, and a program for causing the computer to execute the process.

According to the present disclosure, a more appropriate vehicle network can be formed.

### BRIEF DESCRIPTION OF THE DRAWINGS

Features, advantages, and technical and industrial significance of exemplary embodiments of the present disclosure will be described below with reference to the accompanying drawings, in which like signs denote like elements, and wherein:

FIG. 1 shows a schematic configuration of a system according to an embodiment;

FIG. 2 is a block diagram schematically showing an example of respective configurations of a vehicle and a server included in the system according to the embodiment;

FIG. 3 illustrates a functional configuration of the server according to the embodiment;

FIG. 4 illustrates a table configuration of a vehicle information DB according to the embodiment;

FIG. 5 shows an example of a functional constituent element of an ECU according to the embodiment;

FIG. 6 is a sequence chart showing a whole process in the system according to the first embodiment;

FIG. 7 is a flowchart of a process of deciding on a role of each vehicle, at the server according to the first embodiment;

FIG. 8 is a flowchart of a process at each vehicle according to the first embodiment;

FIG. 9 is a block diagram schematically showing an example of respective configurations of a vehicle and a server included in a system according to a second embodiment;

FIG. 10 is a sequence chart showing a whole process in the system according to the second embodiment;

FIG. 11 is a flowchart of a process at each vehicle according to the second embodiment;

FIG. 12 shows a list of substituting vehicles generated by a control unit of the server;

FIG. 13 is a sequence chart showing a whole process in a system according to a third embodiment;

FIG. 14 is a flowchart of a process of deciding on a role of and a substituting vehicle for each vehicle, at a server according to the third embodiment;

FIG. 15 is a flowchart of a process at each vehicle according to the third embodiment; and

FIG. 16 is a flowchart of a process at each vehicle according to the third embodiment.

### DETAILED DESCRIPTION OF EMBODIMENTS

When a parked vehicle is used for an access point, it is conceivable that the vehicle operating as an access point connects to the Internet by using cellular communication. However, when the number of access points becomes large, there is a possibility that resources for the cellular communication become insufficient, so that the communication rate is lowered.

Accordingly, an information processing device that is one aspect of the present disclosure includes a control unit. The control unit, based on vehicle information on each of a plurality of vehicles parked in a specific area, decides on one or more access-point vehicles to execute an access point mode, which is an operation mode for providing an access point in a vehicle network including the plurality of vehicles. The vehicle information includes position information and information related to a range of vehicle-to-vehicle (V2V) communication, with respect to each vehicle. The control unit is configured to: decide on the one or more access-point vehicles in such a manner that the specific area is covered by the range or ranges of the V2V communication by the one or more access-point vehicles; decide on one or more gateway vehicles to execute a gateway mode, which is an operation mode of connecting the vehicle network to another network, among the vehicles parked in the specific area; and transmit instructions about the operation modes to the one or more access-point vehicles and the one or more gateway vehicles.

The specific area is, for example, an area in which a vehicle network service is provided. The control unit decides on an access-point vehicle to execute the access point mode, from among the vehicles parked in the specific area. The access-point vehicle is a vehicle functioning as an access point when a client uses, for example, the Internet. Here, if a traveling vehicle is an access-point vehicle, there is a possibility that coverage cannot be secured in the specific area because a range in which the access-point vehicle is accessible moves as the access-point vehicle travels. Accordingly, the control unit decides on the access-point vehicle from among the parked vehicles. When deciding on an access-point vehicle or access-point vehicles, the control unit decides in such a manner that the specific area is covered by the range or ranges of V2V communication. In other words, an access-point vehicle or access-point vehicles are decided in such a manner that an access-point vehicle is accessible from any position in the specific area. Such decision is performed based on the position information and the information related to the range of V2V communication with respect to each vehicle. The position information is information indicating a current position of a vehicle. The information related to the range of V2V communication is, for example, information related to a range in which communication at a practical rate is possible. The practical rate can be set arbitrarily.

Moreover, the control unit decides on a gateway vehicle. The gateway vehicle is a vehicle that provides a service of connecting the vehicle network to another network such as the Internet. The gateway vehicle has a gateway function of connecting the vehicle network to another network by performing V2V communication with an access-point vehicle. The gateway vehicle connects to the other network, for example, by using cellular communication. The gateway vehicle is also decided from among the parked vehicles, whereby throughput is restrained from changing.

Then, the control unit transmits the instructions about the operation modes to the access-point vehicle such that the access-point vehicle executes the access point mode, and to the gateway vehicle such that the gateway vehicle executes the gateway mode. Thus, a client in the specific area can connect to the other network via the access-point vehicle and the gateway vehicle. Accordingly, for example, even out of a reach of radio waves of the cellular communication, a client can connect to the Internet. Moreover, for example, by using the cellular communication via the gateway vehicle, a load on the cellular communication can be reduced, compared to using the cellular communication from each access point.

Furthermore, the vehicle information includes information related to throughput in the other network, and the control unit may decide on the one or more gateway vehicles in such a manner that the throughput at a time when each vehicle connects to the other network via the vehicle network is a predetermined value or more. For example, when the number of gateway vehicles is too small for the number of clients, the throughput at each vehicle decreases. To address such a situation, a gateway vehicle or gateway vehicles are decided in such a manner that the throughput is the predetermined value or more, whereby the throughput at each vehicle can be restrained from decreasing too much.

The control unit may decide on the one or more gateway vehicles in such a manner that the number of the gateway vehicles becomes the smallest possible. For example, when there are too many gateway vehicles, the number of gateway vehicles that connect to the other network increases, which leads to, for example, a shortage of resources for the cellular communication. To address such a situation, if a gateway vehicle or gateway vehicles are decided in such a manner that the number of the gateway vehicles becomes the smallest possible, for example, a shortage of resources for the cellular communication can be curbed.

The control unit may be configured to decide on a relay vehicle to execute a relay mode, which is an operation mode for relaying communication between the access-point vehicles, and transmit an instruction about the operation mode to the relay vehicle. By relaying communication between the access-point vehicles, the vehicle network service can be provided over a wider area.

The vehicle information may include information related to voltage of a battery of the vehicle. The control unit may decide on the one or more access-point vehicles and the one or more gateway vehicles among the plurality of vehicles excluding a vehicle of which the voltage of the battery is a predetermined voltage or less. As a result of a vehicle executing the access point mode or the gateway mode while being parked, the voltage of the battery can decrease to the predetermined voltage or less. Note that the predetermined voltage is a voltage that can cause a trouble in traveling. In such a case, when the access point mode or the gateway mode is continued, it can become difficult for the vehicle to travel. The control unit excludes such a vehicle and, from among the remaining vehicles, decides on an access-point vehicle and a gateway vehicle.

The vehicle information may include information related to voltage of a battery of the vehicle, and the control unit may decide on the relay vehicle among the plurality of vehicles excluding a vehicle of which the voltage of the battery is a predetermined voltage or less. Also at the relay vehicle, a too low voltage of the battery can cause a trouble in traveling. A relay vehicle may be decided after such a vehicle is excluded.

The control unit may generate a list including one or more substituting vehicles for each vehicle included in the vehicle network and transmit the list to each of the vehicle included in the vehicle network. All of an access-point vehicle, a gateway vehicle, and a relay vehicle are decided from among the parked vehicles. When such parked vehicles travel, there is a possibility that vehicle network communication is interrupted. Accordingly, when such vehicles travel, substituting vehicles take over the respective operation modes. By generating the list of vehicles that take over the operation modes beforehand, the operation modes can be taken over immediately. Interruptions of communication can be reduced.

The list of the substituting vehicles may include information related to order of priorities of the substituting vehicles. A plurality of vehicles is listed as substituting vehicles, to which priorities are given. For example, even if a higher-priority vehicle has already traveled, the operation mode can be immediately taken over by a next higher-priority vehicle.

Hereinafter, embodiments of the present disclosure are described based on the drawings. Configurations in the embodiments described below are given for illustrative purposes, and the present disclosure is not limited to the configurations in the embodiments. The embodiments described below can be combined to an extent possible.

### First Embodiment

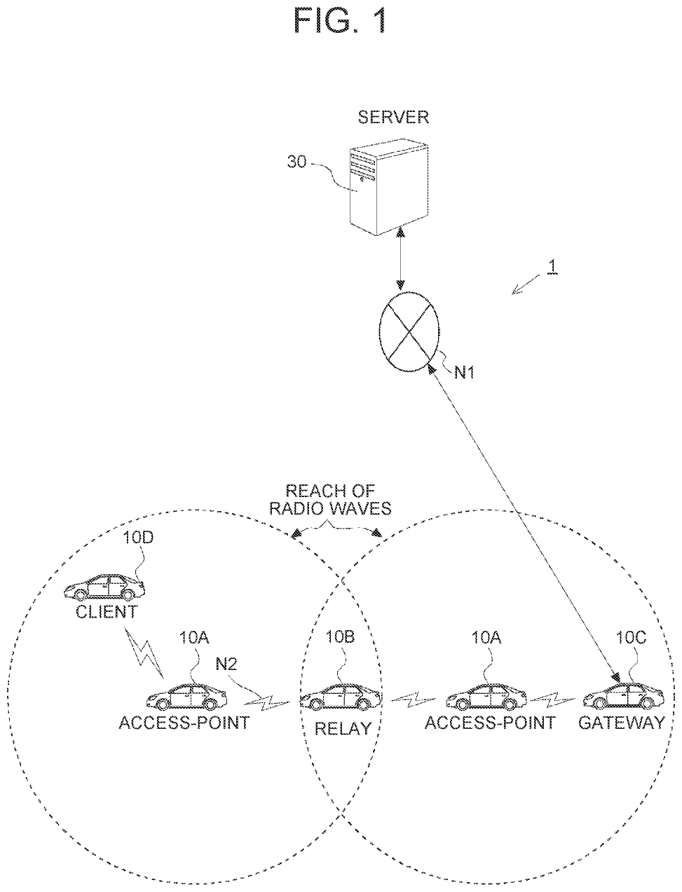

FIG. 1 shows a schematic configuration of a system 1 according to an embodiment. The system 1 decides on roles of a plurality of vehicles 10 as an access point, a relay, or a gateway such that coverage can be secured in a specific area. A vehicle 10 assigned the role of access point is referred to as access-point vehicle 10A. A vehicle 10 assigned the role of relay is referred to as relay vehicle 10B. A vehicle 10 assigned the role of gateway is referred to as gateway vehicle 10C. Moreover, a vehicle 10 that, as a client, accesses an access-point vehicle 10A is referred to as client vehicle 10D. Note that a client that accesses an access-point vehicle 10A is not limited to a client vehicle 10D, but, for example, a terminal, such as smartphone or a personal computer, can also access as a client. When no distinction is made among the access-point vehicle 10A, the relay vehicle 10B, the gateway vehicle 10C, and the client vehicle 10D, the vehicles are simply referred to as vehicle 10. Each vehicle 10 can serve as any of the access-point vehicle 10A, the relay vehicle 10B, the gateway vehicle 10C, and the client vehicle 10D. A single vehicle 10 can play a plurality of roles. There may exist a vehicle 10 that does not play any of the roles.

In the example in FIG. 1, the system 1 includes a plurality of vehicles 10 and one server 30. Each vehicle 10 and the server 30 are connected to each other via a network N1. The network N1 is, for example, a worldwide public telecommunication network such as the Internet. A wide area network (WAN) or any other communication network may be adopted. The network N1 may include a telephone communication network such as a mobile telephone network, or a wireless communication network such as a Wi-Fi® network. Moreover, the vehicles 10 are connected to each other through vehicle-to-vehicle (V2V) communication N2 including a wireless communication network such as a Wi-Fi® network.

Hardware configurations of the vehicles 10 and the server 30 are described based on FIG. 2. FIG. 2 is a block diagram schematically showing an example of the respective configurations of a vehicle 10 and the server 30 included in the system 1 according to the embodiment.

The server 30 has a configuration of a computer. The server 30 includes a processor 301, a main storage unit 302, a secondary storage unit 303, and a communication unit 304. The components are connected to each other through a bus. Note that the processor 301 is an example of a control unit.

The processor 301 is a central processing unit (CPU), a digital signal processor (DSP), or the like. The processor 301 controls the server 30 and performs calculation for various information processing. The main storage unit 302 is a random access memory (RAM), a read only memory (ROM), or the like. The secondary storage unit 303 is an erasable programmable ROM (EPROM), a hard disk drive (HDD), a removable medium, or the like. An operating system (OS), various programs, various tables, and the like are stored in the secondary storage unit 303. The processor 301 loads and executes a program stored in the secondary storage unit 303 on a work area of the main storage unit 302. Each component unit or the like is controlled through the execution of the program. Thus, the server 30 implements a function that coincides with a predetermined purpose. The main storage unit 302 and the secondary storage unit 303 are computer-readable recording media. Information stored in the secondary storage unit 303 may be stored in the main storage unit 302. Information stored in the main storage unit 302 may be stored in the secondary storage unit 303.

Note that in the specific hardware configuration of the server 30, a constituent element can be omitted, substituted, or added as appropriate, depending on an embodiment. For example, the processor 301 of the server 30 may include a plurality of hardware processors. A hardware processor may be configured by using a microprocessor, a FPGA, a GPU, or the like. The server 30 may be configured by using a single computer, or may be configured by using a plurality of computers. In the latter case, hardware configurations of the individual computers may coincide with each other, or do not need to coincide with each other.

The communication unit 304 is means for communicating with each vehicle 10 via the network N1. The communication unit 304 is, for example, a local area network (LAN) interface board, or a wireless communication circuit for wireless communication. The LAN interface board or the wireless communication circuit is connected to the network N1.

Note that a series of processes executed by the server 30 can be executed by hardware, and also can be execute by software.

Next, the vehicle 10 is described. The vehicle 10 includes an ECU 100, which is an electronic control unit, a power switch 105, and a position information sensor 106. The constituent elements are connected to each other through a CAN bus, which is a bus for an in-vehicle network. Note that although the single ECU 100 is included in the present embodiment, instead, controllers corresponding to external communication and engine or motor control may be included, respectively. Moreover, the constituent elements may be implemented, not each as a single module, but by a combination of an in-vehicle device or in-vehicle communication equipment, such as a car navigation system, an electronic control unit (ECU), and the like.

The ECU 100 has a configuration of a computer. The ECU 100 includes a processor 101, a main storage unit 102, a secondary storage unit 103, and a communication unit 104. The components are connected to each other through a bus. The processor 101, the main storage unit 102, and the secondary storage unit 103 are similar to the processor 301, the main storage unit 302, and the secondary storage unit 303 of the server 30, and a description thereof is therefore omitted.

The communication unit 104 is communication means for connecting the vehicle 10 to the network N1 or the V2V communication N2. The communication unit 104 is a circuit for communicating with another device (for example, a vehicle 10, the server 30, or the like) via the network N1 or the V2V communication N2 by using a wireless communication network, such as a mobile communication service network (for example, a telephone communication network of 6th generation (6G), 5th generation (5G), 4th generation (4G), 3rd generation (3G), long term evolution (LTE), or the like), a Wi-Fi® network, or a Bluetooth® network.

The power switch 105 is a switch for activating the vehicle 10 or causing the vehicle 10 to stop functioning, by being pressed by a user. Note that a state where the vehicle 10 is active after the user presses the power switch 105 is referred to as powered-on state, and a state where the vehicle 10 stops functioning after the user presses again the power switch 105 is referred to as powered-off state. The power switch 105 may be an IG switch. The powered-on state corresponds to an IG-on state, and the powered-off state corresponds to an IG-off state.

The position information sensor 106 acquires position information (for example, a latitude and a longitude) on the vehicle 10 in each predetermined period. The position information sensor 106 is, for example, a global positioning system (GPS) reception unit, a wireless communication unit, or the like. The information acquired by the position information sensor 106 is, for example, recorded on the secondary storage unit 103 or the like and transmitted to the server 30.

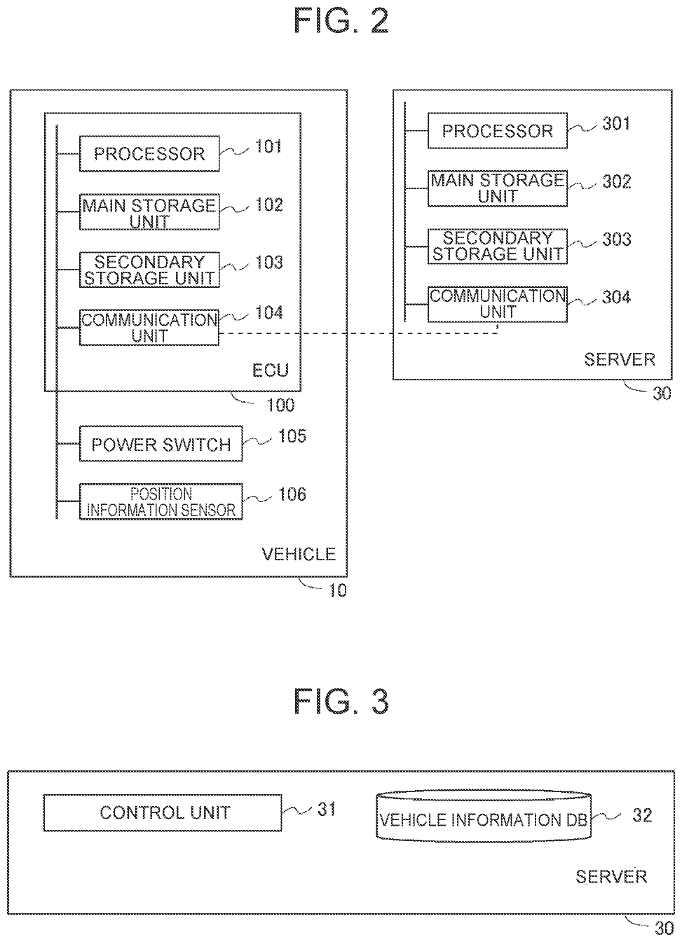

Next, functionality of the server 30 is described. FIG. 3 illustrates a functional configuration of the server 30 according to the embodiment. The server 30 includes, as functional constituent elements, a control unit 31 and a vehicle information DB 32. The processor 301 of the server 30 executes a process by the control unit 31, based on a computer program on the main storage unit 302.

The vehicle information DB 32 is, for example, a relational database that is constructed by a database management system (DBMS) program, which is executed by the processor 301, managing data stored in the secondary storage unit 303.

The control unit 31 receives vehicle information from each vehicle 10. The vehicle information includes information related to a state of the vehicle 10, position information, information related to radio wave strength in the V2V communication N2, and information related to throughput in the network N1. The information related to a state of the vehicle 10 is information indicating whether the vehicle 10 is in the powered-on state or in the powered-off state. The powered-on state and the powered-off state are acquired to determine whether or not the vehicle 10 is parked. In other words, when the vehicle 10 is in the powered-off state, the vehicle 10 cannot travel and it can therefore be determined that the vehicle 10 is parked. When the vehicle 10 is in the powered-on state, the vehicle 10 can immediately travel and it can therefore be determined that the vehicle 10 is traveling or temporarily stopping.

The position information is information related to a current position of the vehicle 10, acquired by the position information sensor 106 of the vehicle 10. The information related to radio wave strength in the V2V communication N2 is information related to a range of the V2V communication N2 and is information related to a reach of radio waves from the vehicle 10. The reach of radio waves may be a range in which the radio wave strength is a predetermined strength or more, or a range in which the communication rate is a predetermined value or more. Such ranges may be ranges in which a practical communication rate can be secured. The information related to throughput in the network N1 is information related to a throughput at a time when the vehicle 10 connects to the network N1. The vehicle information is generated at each vehicle 10 and transmitted to the server 30 in each predetermined period. The control unit 31 stores the received vehicle information in the vehicle information DB 32, which will be described later.

The control unit 31 decides on a role of each vehicle 10, based on the vehicle information received from each vehicle 10, such that each vehicle 10 can connect to the network N1 via the V2V communication N2 within a specific area. Incidentally, the specific area can be decided arbitrarily. For example, specific areas can be decided based on administrative divisions, such as municipalities, or each area as a result of mesh division may be used for a specific area.

Here, the access-point vehicle 10A is a vehicle 10 in the powered-off state, and is a vehicle 10 that serves as an access point and provides a Wi-Fi® service to a client vehicle 10D by using the V2V communication N2. The relay vehicle 10B is a vehicle 10 in the powered-off state, and is a vehicle 10 that relays communication between access-point vehicles 10A. The gateway vehicle 10C is a vehicle 10 in the powered-off state, and is a vehicle 10 that provides a service of connecting another vehicle 10 to the network N1. The client vehicle 10D is a user-side vehicle 10 that uses the Wi-Fi® service via the V2V communication N2. Note that a vehicle 10 that is not assigned any role may be included among vehicles 10 in the powered-off state. The vehicles 10 other than the gateway vehicle 10C connect to the network N1 via the V2V communication N2.

First, the control unit 31 decides on an access-point vehicle 10A. The access-point vehicle 10A is decided in such a manner that coverage is secured within the specific area. The control unit 31 decides on the access-point vehicle 10A based on the state (powered-on state or powered-off state) of each vehicle 10, position information, and radio wave strength in such a manner that the specific area can be covered by the reach of radio waves from the access-point vehicle 10A. At the time, access-point vehicles 10A may be decided, for example, in such a manner that an overlap between the reaches of radio waves becomes the smallest possible. Access-point vehicles 10A may be decided, for example, in such a manner that any point in the specific area comes within the reach of radio waves from any one access-point vehicle 10A and that the number of the access-point vehicles 10A becomes the smallest possible.

Next, the control unit 31 decides on a relay vehicle 10B. The relay vehicle 10B is extracted from among vehicles 10 existing at positions where communication between at least two access-point vehicles 10A can be relayed. Relay vehicles 10B may be decided, for example, in such a manner that all access-point vehicles 10A can communicate with a relay vehicle 10B. At the time, the relay vehicles 10B may be decided, for example, in such a manner that the number of the relay vehicles 10B becomes the smallest possible.

Further, the control unit 31 decides on one or more gateway vehicles 10C. For example, each gateway vehicle 10C is extracted from among vehicles 10 that have relatively large throughputs in the specific area. Gateway vehicles 10C may be decided, while the number of surrounding client vehicles 10D, a required bandwidth, and the like are taken into consideration, in such a manner that the number of the gateway vehicles 10C becomes the smallest to the extent that the throughput per client vehicle 10D is a predetermined value (for example, 10 Mbps) or more. In other words, since a load on the network N1 becomes large when there are too many gateway vehicles 10C, the number of gateway vehicles 10C may be prevented from becoming too large.

Moreover, the control unit 31 decides on all vehicles 10 in the powered-on state as client vehicles 10D. Note that the control unit 31 does not need to decide on client vehicles 10D if each vehicle 10 in the powered-on state is configured to automatically operate as a client vehicle 10D.

The control unit 31 transmits information related to the decided role of each vehicle 10 to each vehicle 10. At the time, an operation instruction including information related to an operation mode is transmitted from the server 30 to each vehicle 10. Operation modes include an access point mode, a relay mode, a gateway mode, and a client mode. The access point mode is a mode for causing a vehicle 10 to operate as an access-point vehicle 10A. The relay mode is a mode for causing a vehicle 10 to operate as a relay vehicle 10B. The gateway mode is a mode for causing a vehicle 10 to operate as a gateway vehicle 10C. The client mode is a mode for causing a vehicle 10 to operate as a client vehicle 10D. The role of each vehicle 10 is stored in the vehicle information DB 32. Note that the control unit 31 does not need to transmit the operation instruction to the client vehicles 10D if each vehicle 10 in the powered-on state is configured such that the client mode is automatically executed on the vehicle 10 side.

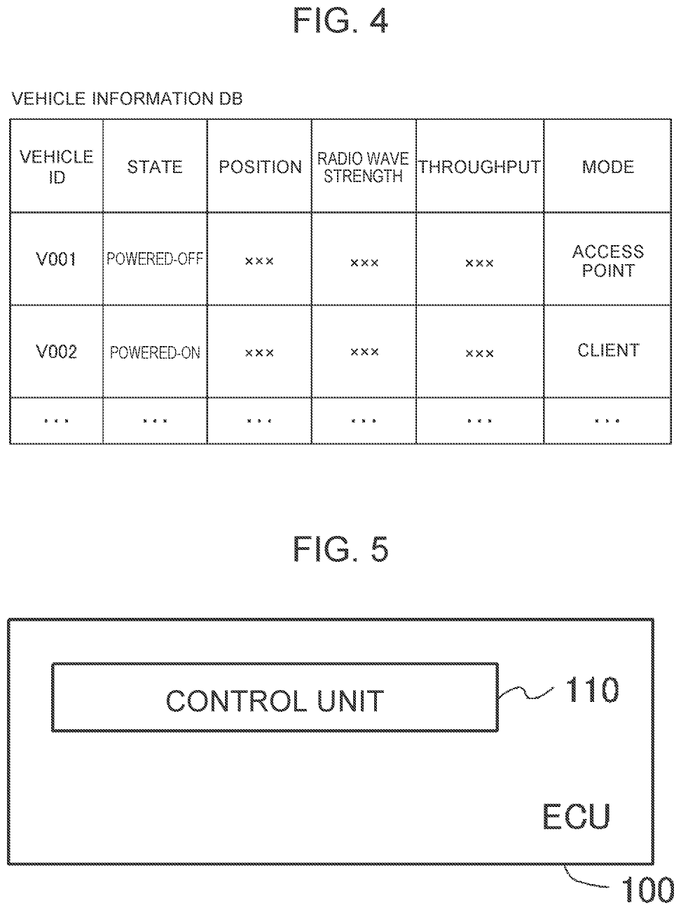

Here, FIG. 4 illustrates a table configuration of the vehicle information DB 32 according to the embodiment. The vehicle information DB 32 includes respective fields of vehicle ID, state, position, radio wave strength, throughput, and mode. In the vehicle ID field, information (a vehicle ID) by which each vehicle 10 can be identified is stored. In the state field, information related to an activation state of each vehicle 10 is stored. For example, information is stored by which it can be determined which of the powered-off state and the powered-on state a state is. As another example, information may be stored by which it can be determined which of IG-on and IG-off a state represents. In the position field, information related to a current position of each vehicle 10 is stored. In the radio wave strength field, information related to a radio wave strength of each vehicle 10 in the V2V communication N2 (for example, Wi-Fi®) is stored. In the throughput field, information related to a throughput of each vehicle 10 in the network N1 (for example, a cellular communication service) is stored. In the mode field, information related to an operation mode that is being executed by each vehicle 10 is stored.

Next, a functional constituent element of the ECU 100 of each vehicle 10 is described. FIG. 5 shows an example of a functional constituent element of the ECU 100 according to the embodiment. The ECU 100 includes a control unit 110 as a functional constituent element. The processor 101 of the ECU 100 executes a process by the control unit 110, based on a computer program on the main storage unit 102. However, any one or some of functional constituent elements, or part of the process by the functional constituent elements, may be executed by a hardware circuit.

The control unit 110 transmits vehicle information to the server 30 in each predetermined period. The vehicle information includes information related to a state of the vehicle 10, position information, information related to radio wave strength in the V2V communication N2, and information related to throughput in the network N1. The control unit 110 acquires the information related to a state of the vehicle 10, based on an input to the power switch 105. The control unit 110 acquires the position information, based on an output signal from the position information sensor 106. The control unit 110 further acquires the information related to radio wave strength in the V2V communication N2 and the information related to throughput in the network N1, based on a result of communication via the communication unit 104. The control unit 110 generates vehicle information including such information and transmits the vehicle information to the server 30.

Moreover, when the control unit 110 receives an operation instruction including information related to an operation mode from the server 30, the control unit 110 executes the operation mode. In other words, the control unit 110 executes an operation mode in such a manner as to play a role assigned by the server 30. The control unit 110 of an access-point vehicle 10A provides, for example, the Wi-Fi® service. The control unit 110 of a relay vehicle 10B relays communication between access-point vehicles 10A. The control unit 110 of a gateway vehicle 10C provides connection to, for example, the Internet. The control unit 110 of a client vehicle 10D uses, for example, the Wi-Fi® service through communication with an access-point vehicle 10A.

Note that when the vehicle 10 changes from the powered-off state to the powered-on state, the control unit 110 may execute the client mode. Since only the client mode can be executed in the powered-on state, the operation mode may be changed to the client mode even if an operation instruction from the server 30 is not received. In such a case, the control unit 110 may notify the server 30 that the operation mode is changed to the client mode.

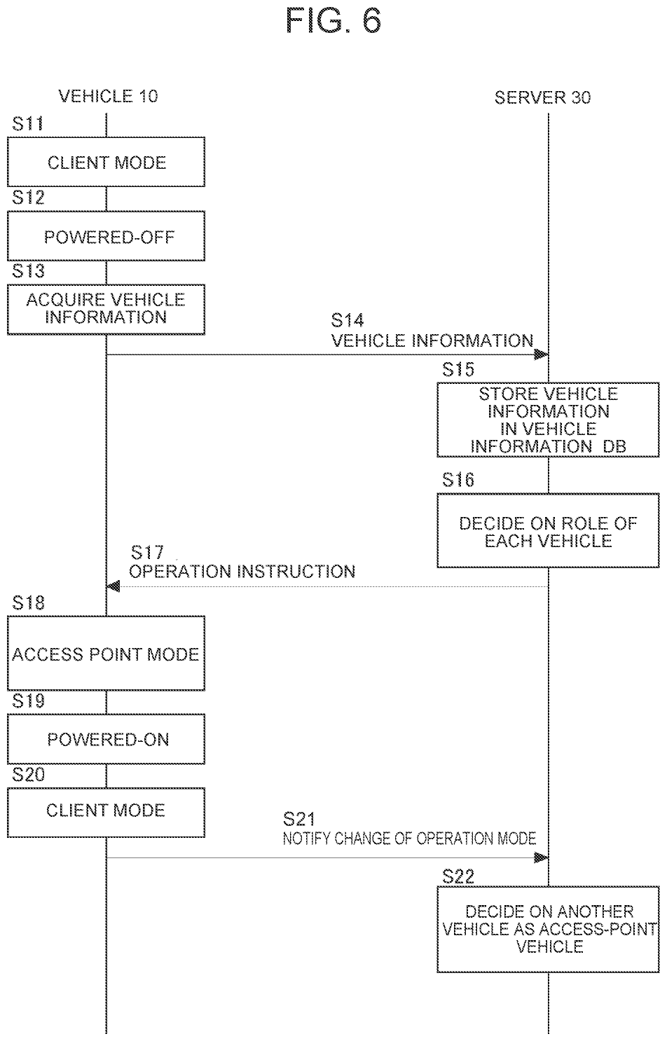

Next, a whole process in the system 1 is described. FIG. 6 is a sequence chart showing the whole process in the system 1 according to the first embodiment. In FIG. 6, an example is described in which a vehicle 10 is decided as an access-point vehicle 10A. The process starts in a state where the vehicle 10 is in the powered-on state and is executing the client mode.

In the powered-on state, the control unit 110 of the vehicle 10 is executing the client mode (S11). When the power switch 105 is pressed, the vehicle 10 changes into the powered-off state (S12). The control unit 110 of the vehicle 10 acquires vehicle information (S13) and transmits the vehicle information to the server 30 (S14). A timing of acquiring vehicle information may be a time point when a change into the powered-off state occurs, or may be in each predetermined period irrespective of whether or not a change into the powered-off state occurs. Moreover, in order to determine that the vehicle 10 is parked, a change into the powered-off state is determined in the present embodiment. However, not only by such a method, the fact that the vehicle 10 is parked may be determined through another method. For example, when the doors are locked in the powered-off state, it may be determined that the vehicle 10 is parked. In such a case, information related to locking of the doors may be included in the vehicle information. A vehicle ID is associated with the vehicle information.

When the vehicle information is received, the control unit 31 of the server 30 stores the vehicle information in the vehicle information DB 32 (S15). The control unit 31 of the server 30 decides on a role of each vehicle 10, based on the vehicle information on each vehicle 10 (S16). When the role of each vehicle 10 is decided, the control unit 31 of the server 30 stores information related to operation modes in the vehicle information DB 32 and transmits an operation instruction to each vehicle 10 (S17). The operation instruction includes information related to an operation mode to be executed by each vehicle 10. In the example shown in FIG. 6, an instruction to execute the access point mode is included.

When the operation instruction is received, the control unit 110 of the vehicle 10 executes the operation mode according to the operation instruction. In the example shown in FIG. 6, the control unit 110 executes the access point mode (S18). Thus, the vehicle 10 functions as an access point. Note that when the operation instruction includes an instruction to execute the relay mode, the control unit 110 executes the relay mode. When the operation instruction includes an instruction to execute the gateway mode, the control unit 110 executes the gateway mode. The operation instruction may include an instruction to execute a plurality of operation modes, in some cases.

When the power switch 105 of the vehicle 10 is pressed and a change into the powered-on state occurs (S19), the control unit 110 of the vehicle 10 executes the client mode (S20). Moreover, the control unit 110 of the vehicle 10 notifies the server 30 that the operation mode has changed to the client mode (S21). The notification may be performed by transmitting vehicle information. For example, if the fact of being in the powered-on state is notified to the server 30, the control unit 31 of the server 30 can determine that the vehicle 10 is executing the client mode. The control unit 31 of the server 30 that has received the notification decides on a new access-point vehicle 10A (S22). In other words, since the number of access-point vehicles 10A decreases by one, another vehicle 10 is decided as an access-point vehicle 10A such that coverage is secured. At the time, the process may return to S16, where a role of each vehicle 10 may be decided again, or only a substituting access-point vehicle 10A may be decided.

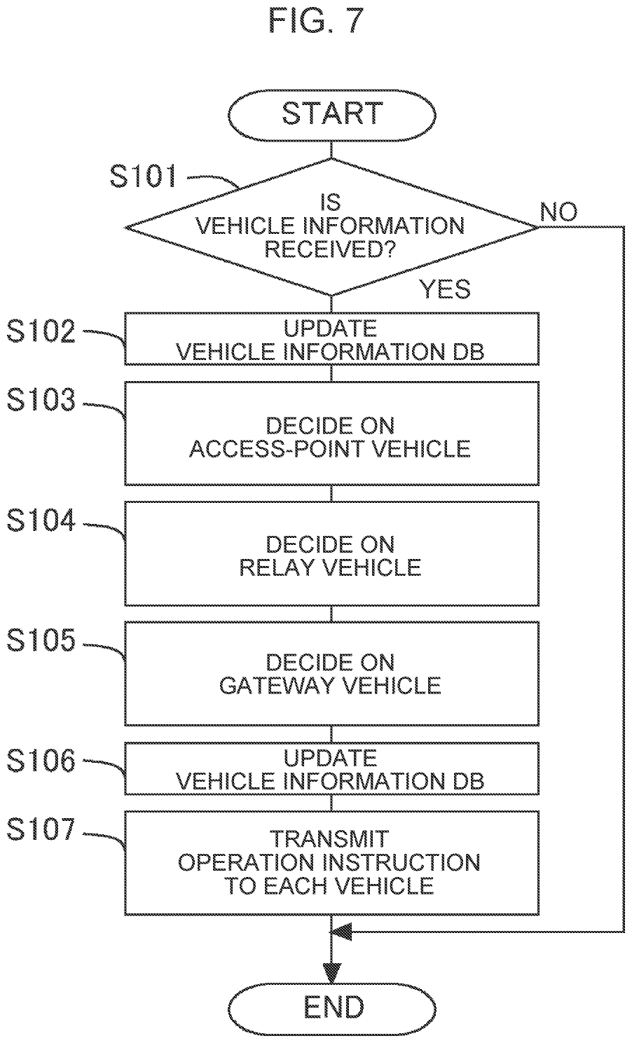

Next, a process, at the server 30, of deciding on a role of each vehicle 10 is described. FIG. 7 is a flowchart of the process of deciding on a role of each vehicle 10 at the server 30 according to the first embodiment. The process shown in FIG. 7 is executed at the server 30 in each predetermined period. Note that a description is given based on the premise that at each vehicle 10 in the powered-on state, the operation mode changes to the client mode on the vehicle 10 side.

In step S101, the control unit 31 determines whether or not vehicle information is received from a vehicle 10. Note that the vehicle information may be transmitted from a vehicle 10, for example, when the vehicle 10 is powered off or powered on, or may be transmitted from each vehicle 10 in each predetermined period. When an affirmative determination is made in step S101, the process proceeds to step S102, and a negative determination terminates the present routine.

In step S102, the control unit 31 updates the vehicle information DB 32 by storing the received vehicle information in the vehicle information DB 32. In step S103, the control unit 31 decides on an access-point vehicle 10A, based on the vehicle information. The control unit 31 may decide on access-point vehicles 10A, for example, in such a manner that the number of the access-point vehicles 10A becomes the smallest possible to secure coverage in the specific area. As another example, access-point vehicles 10A may be decided in such a manner that an area accounting for a predetermined proportion of the specific area is included in the reaches of radio waves. The predetermined proportion can be set arbitrarily. As another example, access-point vehicles 10A may be decided in such a manner that vehicles 10 accounting for a predetermined proportion of vehicles 10 in the powered-on state located within the specific area are included in the reaches of radio waves. The predetermined proportion can also be set arbitrarily.

In step S104, the control unit 31 decides on a relay vehicle 10B, based on the vehicle information. The control unit 31 decides on a vehicle 10 existing at a position where communication between access-point vehicles 10A is relayed, as a relay vehicle 10B. Relay vehicles 10B may also be decided in such a manner that the number thereof becomes the smallest possible.

In step S105, the control unit 31 decides on a gateway vehicle 10C, based on the vehicle information. The control unit 31 decides on a vehicle 10 having a relatively large throughput, as a gateway vehicle 10C. At the time, it can be calculated how many vehicles 10 can be provided with a communication service from the gateway vehicle 10C, based on the throughput of the gateway vehicle 10C and a throughput used in communication provided to each vehicle 10. At the time, the gateway vehicle 10C is decided on the assumption that the communication service is provided to each vehicle 10 at a predetermined throughput. Note that as the number of gateway vehicles 10C becomes smaller, the load on the network N1 (for example, of the cellular communication service) can be reduced. Accordingly, gateway vehicles 10C may be decided in such a manner that the number of the gateway vehicles 10C becomes the smallest to the extent that the communication service can be provided to each vehicle 10 at the predetermined throughput.

In step S106, the control unit 31 updates the mode field of the vehicle information DB 32, according to the role of each vehicle 10. Subsequently in step S107, the control unit 31 generates and transmits an operation instruction to each vehicle 10.

Note that although the access-point vehicle 10A, the relay vehicle 10B, and the gateway vehicle 10C are decided in the same order as mentioned in the above description, the order may be changed. The access-point vehicle 10A, the relay vehicle 10B, and the gateway vehicle 10C may be decided at the same time.

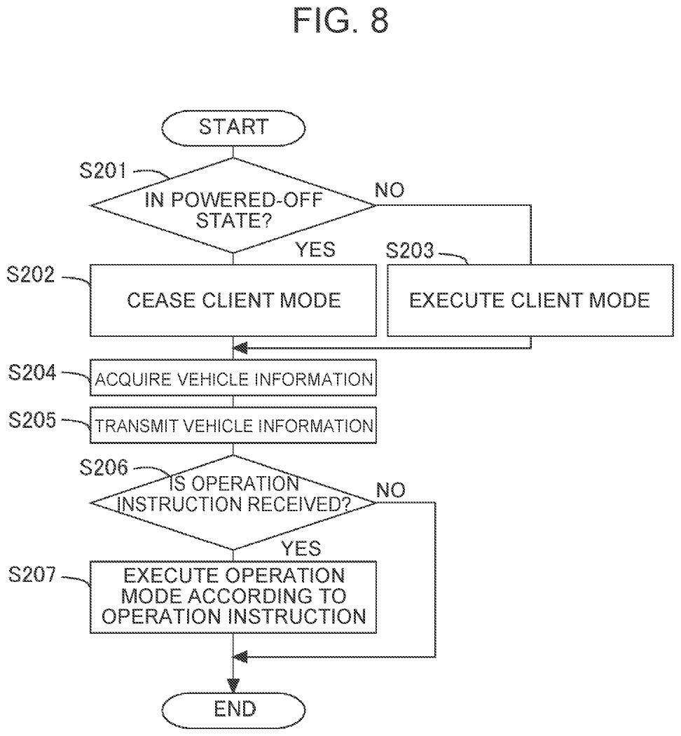

Next, a process at each vehicle 10 is described. FIG. 8 is a flowchart of the process at each vehicle 10 according to the first embodiment. The process shown in FIG. 8 is executed at each vehicle 10 in each predetermined period.

In step S201, the control unit 110 determines whether or not the vehicle 10 is in the powered-off state. The process proceeds to step S202 when an affirmative determination is made in step S201, and proceeds to step S203 when a negative determination is made. In step S202, the control unit 110 ceases the client mode. In other words, when the vehicle 10 is in the powered-off state, the client mode is ceased in order to set the operation mode to a mode other than the client mode. Note that when the client mode is already ceased, the client mode continues not to be executed. In contrast, in step S203, the control unit 110 executes the client mode. Since only the client mode can be executed when the vehicle 10 is in the powered-on state, the control unit 110 automatically executes the client mode. Note that when the client mode is already executed, the client mode continues to be executed.

In step S204, the control unit 110 acquires vehicle information. The control unit 110 acquires the vehicle information by acquiring an output value of each sensor. Further in step S205, the control unit 110 transmits the acquired vehicle information to the server 30.

In step S206, the control unit 110 determines whether or not an operation instruction is received from the server 30. When an affirmative determination is made in step S206, the process proceeds to step S207. In step S207, the control unit 110 executes an operation mode according to the operation instruction. When a negative determination is made in step S206, the present routine is terminated. In such a case, an operation mode that is being executed at a current time point continues to be executed.

As described hereinabove, according to the present embodiment, a communication network can be formed by a plurality of vehicles 10. Moreover, since the number of vehicles 10 connecting to the network N1 can be reduced, the load on the network N1 can be lowered.

### Second Embodiment

In a second embodiment, a network of vehicles 10 is formed, with further a remaining charge of a battery of a vehicle 10 factored in. Here, when the access point mode, the relay mode, or the gateway mode is executed while a vehicle 10 is powered off, the remaining charge of the battery may decrease in some cases. When the remaining charge of the battery becomes too little, the voltage of the battery decreases, so that a trouble may be caused in traveling of the vehicle 10. Accordingly, in the present embodiment, when battery voltage becomes a predetermined voltage or less, the access point mode, the relay mode, or the gateway mode is ceased. The operation modes may be ceased based on determination by the control unit 110 of each vehicle 10, or based on determination by the control unit 31 of the server 30. When determination by the control unit 31 of the server 30 is based on, information related to battery voltage is included in vehicle information transmitted from each vehicle 10 to the server 30. Then, the control unit 31 of the server 30 determines whether or not battery voltage is the predetermined voltage or less. When it is determined that battery voltage is the predetermined voltage or less, the control unit 31 instructs the vehicle 10 to cease the operation mode.

When the control unit 110 of a vehicle 10 determines whether or not battery voltage is the predetermined voltage or less, and when it is determined that battery voltage is the predetermined voltage or less, the control unit 110 may cease the operation mode. In such a case, it may be notified to the server 30 that the operation mode is ceased.

When there is a vehicle 10 that ceases the operation mode, the control unit 31 of the server 30 reconstructs a communication network of the vehicles 10.

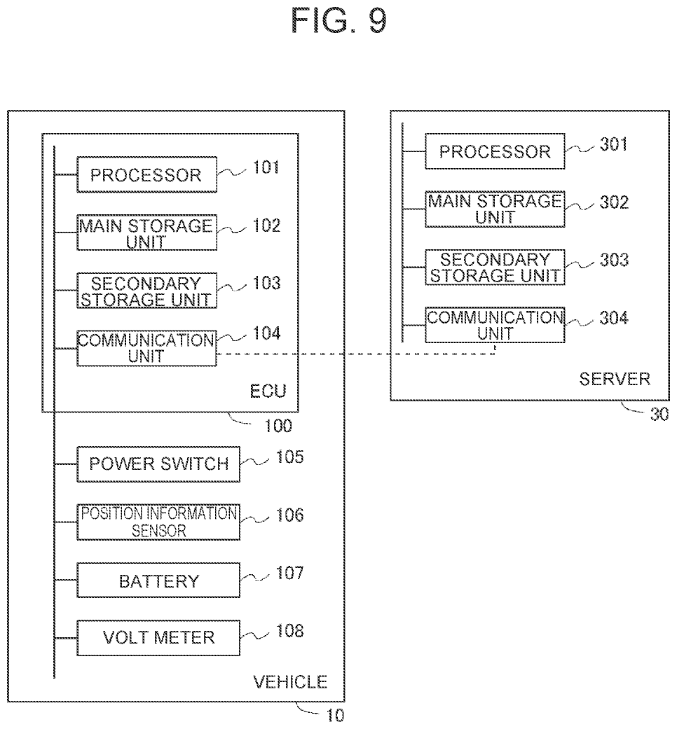

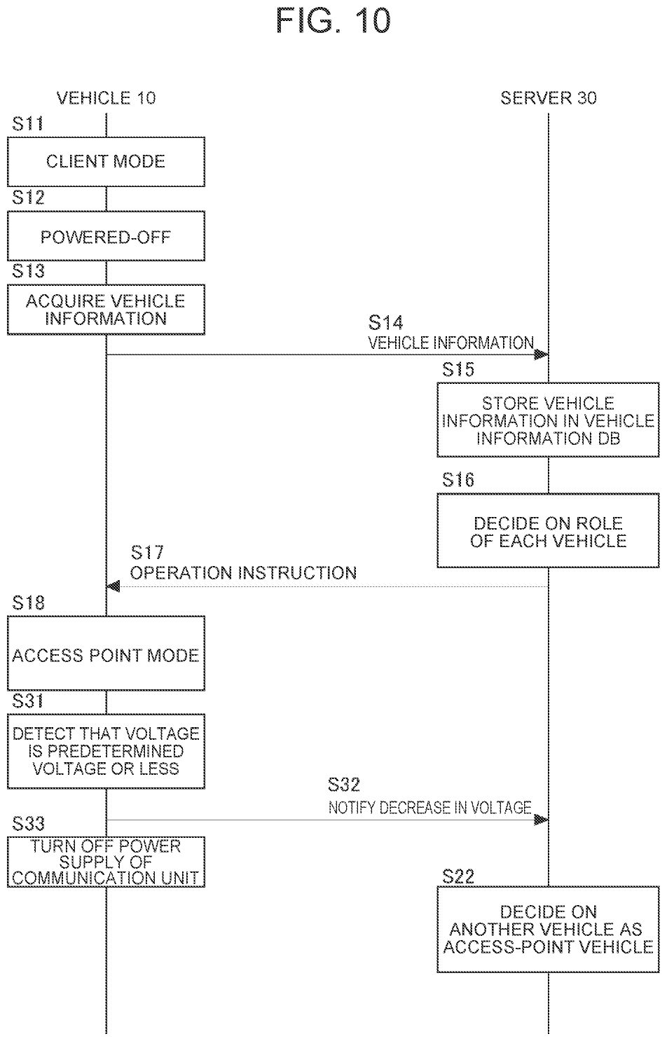

FIG. 9 is a block diagram schematically showing an example of respective configurations of a vehicle 10 and the server 30 included in the system 1 according to a second embodiment. Differences from the configurations shown in FIG. 2 are mainly described. The vehicle 10 includes a battery 107 and a volt meter 108 that measures the voltage of the battery 107. The control unit 110 of the vehicle 10 acquires the voltage of the battery 107 from the volt meter 108.

Next, a whole process in the system 1 is described. FIG. 10 is a sequence chart showing the whole process in the system 1 according to the second embodiment. In FIG. 10, an example is described in which a vehicle 10 is decided as an access-point vehicle 10A. The process starts in a state where the vehicle 10 is in the powered-on state and is executing the client mode. Since the process up to S18 is the same as that in the sequence chart shown in FIG. 6, a description thereof is omitted.

In the sequence chart shown in FIG. 10, the control unit 110 acquires a battery voltage after a change to the access point mode is made. When electricity is not supplied to the battery of the vehicle 10, the voltage of the battery gradually decreases while the access point mode is being executed. When it is detected that the battery voltage is a predetermined voltage or less (S31), the control unit 110 notifies the server 30 that the voltage has decreased (S32). Note that the notification (hereinafter, also referred to as voltage decrease notification) may be included in vehicle information. Further, the control unit 110 turns off a power supply of the communication unit 104 (S33). Note that as another example, running of the communication unit 104 may be limited. The limitation of running may be interruption of communications corresponding to the operation mode. The operation mode that is being executed may be ceased.

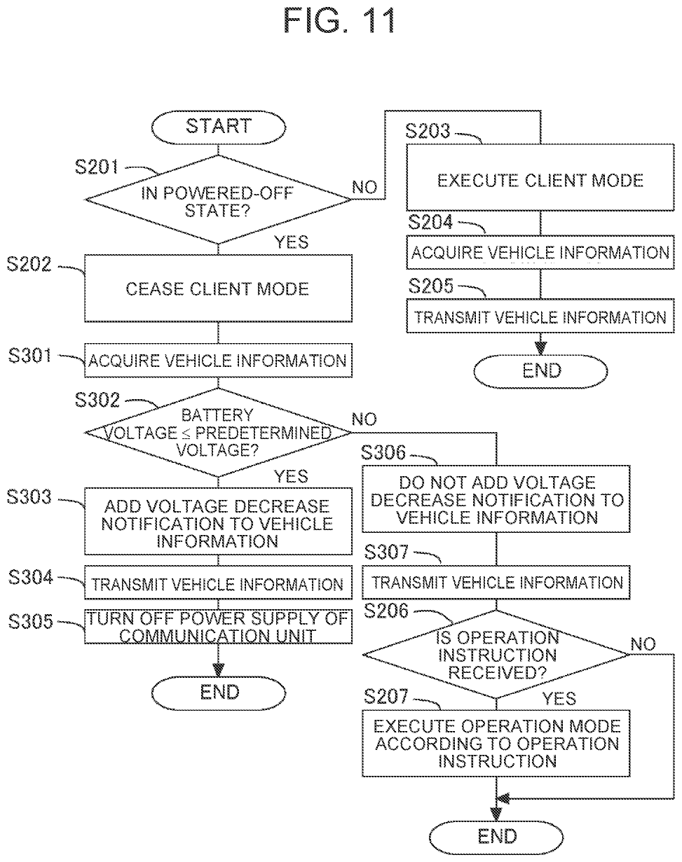

Next, a process at each vehicle 10 is described. FIG. 11 is a flowchart of the process at each vehicle 10 according to the second embodiment. The process shown in FIG. 11 is executed at each vehicle 10 in each predetermined period. The same process steps as those of the routine shown in FIG. 8 are denoted by the same reference sings, and a description thereof is omitted.

In the flowchart shown in FIG. 11, when the process in step S202 is finished, the process proceeds to step S301. In step S301, the control unit 110 acquires vehicle information. At the time, a voltage of the battery 107 is acquired from the volt meter 108, in addition to the information acquired in step S204 of the routine shown in FIG. 8. In step S302, the control unit 110 determines whether or not the voltage of the battery 107 is a predetermined voltage or less. The predetermined voltage is a voltage that may cause a trouble in traveling of the vehicle 10. As an example of the predetermined voltage, for example, a voltage required to restart an engine may be set. As another example, the predetermined voltage may be a voltage at which a vehicle 10 can travel a predetermined distance. Information related to the predetermined voltage is stored in the secondary storage unit 103.

When an affirmative determination is made in step S302, the process proceeds to step S303. In step S303, the control unit 110 generates vehicle information in such a manner that the vehicle information includes a voltage decrease notification. In step S304, the control unit 110 transmits the generated vehicle information to the server 30. Further in step S305, the control unit 110 turns off the power supply of the communication unit 104. Note that as another example, the control unit 110 may limit communications by the communication unit 104, or may cease executing the operation mode.

When a negative determination is made in step S302, the process proceeds to step S306. In step S306, the control unit 110 generates vehicle information in such a manner that the vehicle information includes no voltage decrease notification. Note that the vehicle information may include information related to voltage. In step S307, the control unit 110 transmits the generated vehicle information to the server 30.

As described hereinabove, according to the second embodiment, when a vehicle 10 performs communication in the powered-off state, it is possible to prevent a trouble in traveling of the vehicle 10 caused by a decrease in remaining charge of the battery 107.

### Third Embodiment

In a third embodiment, a substituting vehicle 10 for a vehicle 10 that is executing the access point mode, the relay mode, or the gateway mode is decided beforehand. Here, when the vehicle 10 executing the access point mode, the relay mode, or the gateway mode changes from the powered-off state to the powered-on state, the vehicle 10 shifts to the client mode. When the vehicle 10 executing the access point mode, the relay mode, or the gateway mode becomes absent, there is a possibility that communication is interrupted. If the control unit 31 of the server 30 constructs a new network and decides on a role of each vehicle 10 after communication is interrupted, there is a possibility that a time period for which communication is disabled is prolonged. To address such a problem, in the third embodiment, a vehicle 10 that next executes the access point mode, the relay mode, or the gateway mode is decided beforehand. When a vehicle 10 that executes the access point mode, the relay mode, or the gateway mode becomes absent, the next vehicle 10 immediately takes over the role. Thus, communication can be prevented from being interrupted, or the time period for which communication is disabled can be shortened.

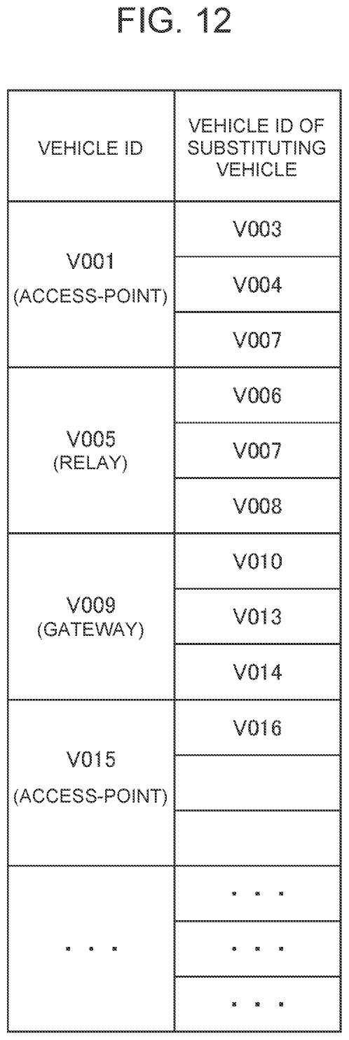

FIG. 12 shows a list of substituting vehicles generated by the control unit 31 of the server 30. A substituting vehicle is a vehicle 10 to execute the access point mode, the relay mode, or the gateway mode in place of a vehicle 10 that has been executing the access point mode, the relay mode, or the gateway mode. For example, in case of an access-point vehicle 10A with a vehicle ID of V001, three vehicles 10 with vehicle IDs of V003, V004, V007 as substituting vehicles are listed as candidates. It is assumed that an upper row of the list has a higher priority. Accordingly, when the vehicle 10 with the vehicle ID of V001 becomes no longer an access-point vehicle 10A, the vehicle 10 with the vehicle ID of V003 next serves as an access-point vehicle 10A. The same applies to the relay vehicle 10B and the gateway vehicle 10C.

The list shown in FIG. 12 is generated by the control unit 31 of the server 30 such that a network can be maintained, that is, coverage can be secured even if an operation mode is handed over to a substituting vehicle. Note that when there is no substituting vehicle that can secure coverage, a role of each vehicle 10 may be decided as described in the first embodiment.

The list shown in FIG. 12 may be transmitted to each vehicle 10 beforehand and stored in the secondary storage unit 103 of each vehicle 10. When activation states are mutually notified between vehicles 10 through the V2V communication N2 and the presence of a vehicle 10 that ceases the access point mode, the relay mode, or the gateway mode is detected, the control unit 110 of a vehicle 10 having the highest priority may execute the access point mode, the relay mode, or the gateway mode. Thus, communication is prevented from being interrupted. Note that hereinafter, a description is given where a substituting vehicle is denoted by a reference sign “20”.

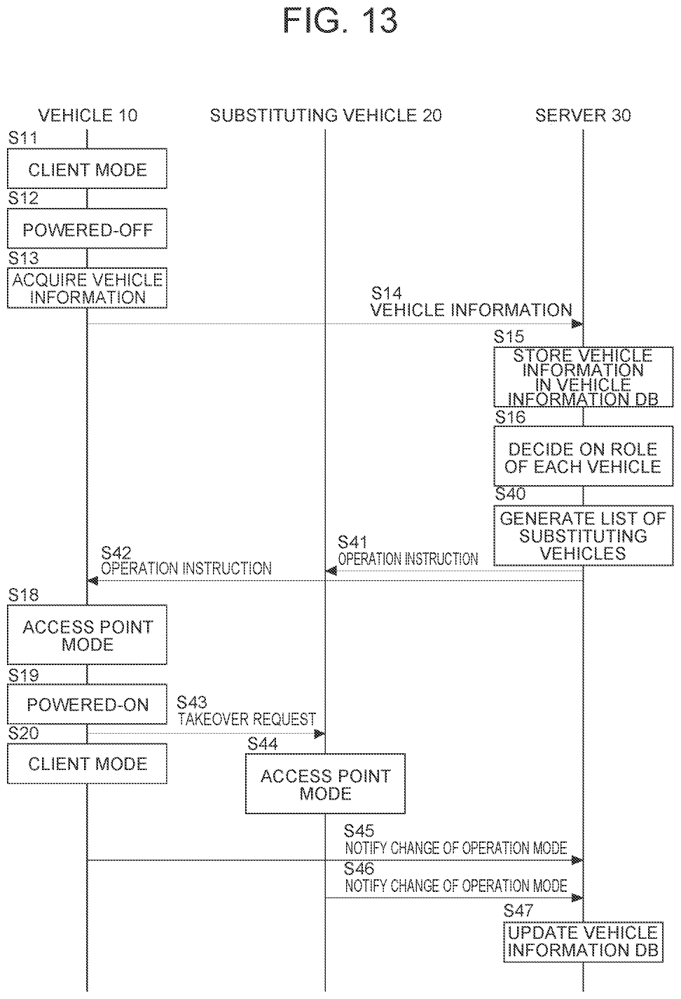

Next, a whole process in the system 1 is described. FIG. 13 is a sequence chart showing the whole process in the system 1 according to the third embodiment. In FIG. 13, an example is described in which a vehicle 10 is decided as an access-point vehicle 10A. The process starts in a state where the vehicle 10 is in the powered-on state and is executing the client mode. A substituting vehicle 20 is a vehicle 10 that is in the powered-off state and is not executing the access point mode, the relay mode, or the gateway mode. Note that as another example, a substituting vehicle 20 may be a vehicle 10 that is executing at least one mode of the relay mode and the gateway mode. Since the process up to S16 is the same as that in the sequence chart shown in FIG. 6, a description thereof is omitted.

In the sequence chart shown in FIG. 13, after a role of each vehicle 10 is decided, the list shown in FIG. 12 is generated (S40). The control unit 31 of the server 30 decides on a substituting vehicle 20 for each vehicle 10 of which the role has been decided, respectively. The number of substituting vehicles 20 is not limited as long as the number is one or more. The list is transmitted together with an operation instruction to each vehicle 10 and each substituting vehicle 20 (S41, S42).

When the vehicle 10 changes into the powered-on state (S19), a request to take over access-point vehicle 10A is sent to a substituting vehicle 20 having the highest priority among the substituting vehicles 20 for the vehicle 10 in the list received in S42 (S43). At the time, it may be confirmed whether or not the substituting vehicle 20 can execute the access point mode as a substituting vehicle 20. For example, when the substituting vehicle 20 having the highest priority is also in the powered-on state already, a request to take over access-point vehicle 10A may be further sent to a substituting vehicle 20 having a lower priority.

The substituting vehicle 20 that has received the notification in S43 executes the access point mode (S44). On the other hand, the vehicle 10 executes the client mode (S20), and it is notified from the vehicle 10 to the server 30 that the operation mode has changed to the client mode (S45). The notification may include the fact that a substituting vehicle 20 has taken over the access point mode, and information about the vehicle ID of the substituting vehicle 20. The control unit 110 of the substituting vehicle 20 executing the access point mode notifies the server 30 that the operation mode has changed to the access point mode (S46). The control unit 31 of the server 30 that has received the notifications updates the mode field of the vehicle information DB 32 (S47).

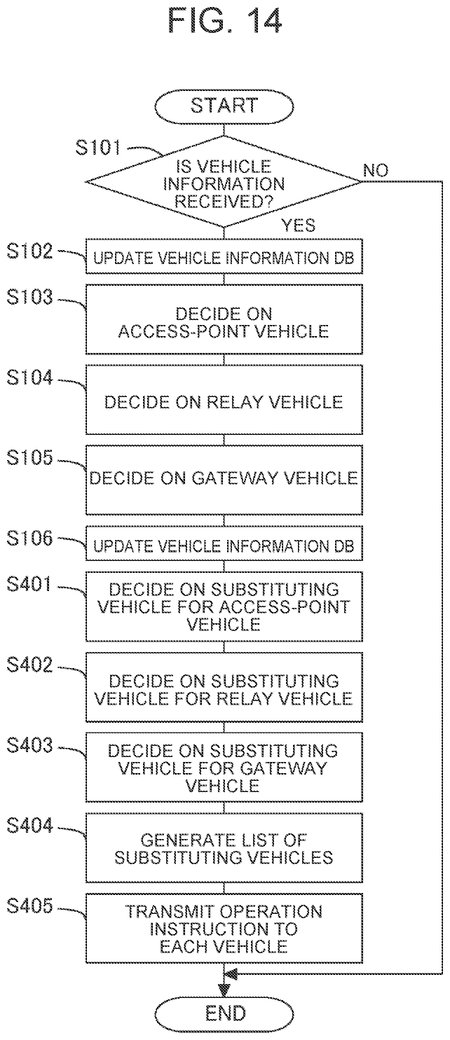

FIG. 14 is a flowchart of a process of deciding on a role of and a substituting vehicle 20 for each vehicle 10, at the server 30 according to the third embodiment. The process shown in FIG. 14 is executed at the server 30 in each predetermined period. Note that a description is given based on the premise that at each vehicle 10 in the powered-on state, the operation mode changes to the client mode on the vehicle 10 side. The same process steps as those of the routine shown in FIG. 7 are denoted by the same reference sings, and a description thereof is omitted.

In the routine shown in FIG. 14, after the process in step S106, the process proceeds to step S401. In step S401, the control unit 31 decides on a substituting vehicle 20 for the access-point vehicle 10A. The substituting vehicle 20 for the access-point vehicle 10A is decided from among vehicles 10 that can secure coverage when serving as an access point in place of the access-point vehicle 10A. At the time, substituting vehicles 20 may be decided by being given priorities in descending order of radio wave strength. As another example, substituting vehicles 20 for the access-point vehicle 10A may be decided from among vehicles 10 within a predetermined distance from the access-point vehicle 10A by being given priorities, for example, in descending order of radio wave strength. The predetermined distance here is set beforehand as a distance that causes little effect on securing coverage. Note that the substituting vehicles 20 for the access-point vehicle 10A may include the vehicle 10 decided as a relay vehicle 10B or a gateway vehicle 10C.

In step S402, the control unit 31 decides on a substituting vehicle 20 for the relay vehicle 10B. The substituting vehicle 20 for the relay vehicle 10B is decided from among vehicles 10 that can relay communication between access-point vehicles 10A that the relay vehicle 10B is relaying. Such substituting vehicles 20 may be decided from among vehicles 10 within a predetermined distance from the relay vehicle 10B by being given priorities, for example, in descending order of radio wave strength. The predetermined distance here is set beforehand as a distance that causes little effect on securing coverage. The substituting vehicles 20 for the relay vehicle 10B may include the vehicle 10 decided as an access-point vehicle 10A or a gateway vehicle 10C.

In step S403, the control unit 31 decides on a substituting vehicle 20 for the gateway vehicle 10C. The substituting vehicle 20 for the gateway vehicle 10C is decided from among vehicles 10 that can communicate with the access-point vehicle 10A or the relay vehicle 10B. Such substituting vehicles 20 may be decided by being given priorities, for example, in descending order of throughput in the network N1. The substituting vehicles 20 for the gateway vehicle 10C may include the vehicle 10 decided as an access-point vehicle 10A or a relay vehicle 10B.

In step S404, the control unit 31 generates a list of the substituting vehicles 20. The generated list is stored in the secondary storage unit 303. In step S404, the control unit 31 transmits an operation instruction and the list of the substituting vehicles 20 to each vehicle 10.

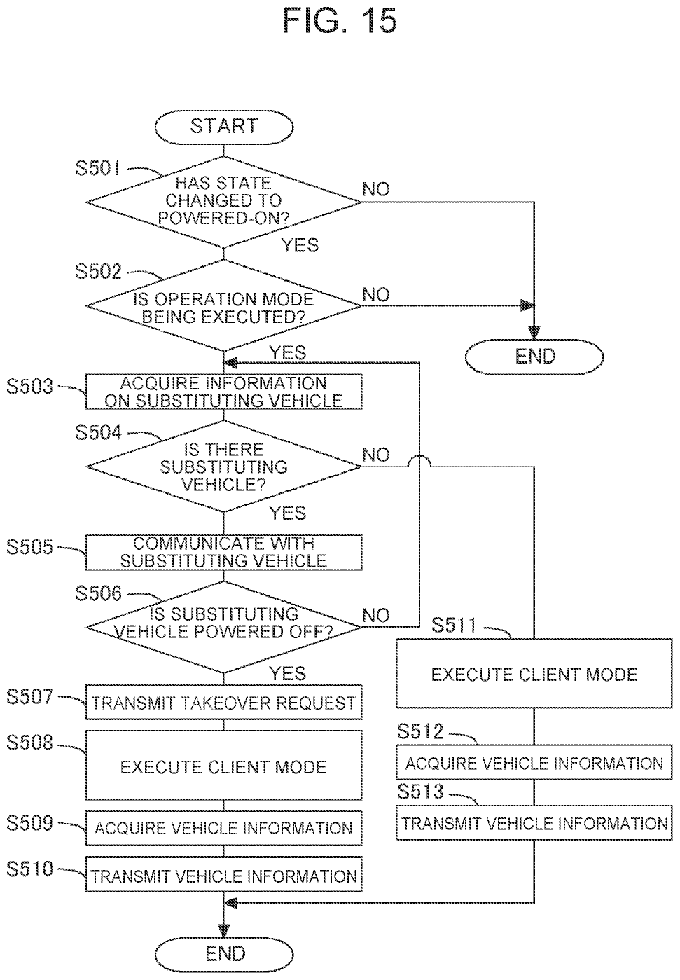

Next, a process at each vehicle 10 is described. FIG. 15 is a flowchart of the process at each vehicle 10 according to the third embodiment. The process shown in FIG. 15 is executed at a vehicle 10 that has changed from the powered-off state to the powered-on state. A description is given based on the promise that a list of substituting vehicles 20 has been transmitted from the server 30 to each vehicle 10.

In step S501, the control unit 110 determines whether or not the state of the vehicle 10 has changed from powered-off to powered-on. For example, the control unit 110 determines whether or not the state has changed from powered-off to powered-on by determining whether or not the power switch 105 is pressed in the powered-off state. When an affirmative determination is made in step S501, the process proceeds to step S502, and a negative determination terminates the present routine. Note that when a negative determination is made in step S501, the routine shown in FIG. 8 or FIG. 11 may be executed.

In step S502, the control unit 110 determines whether or not any one operation mode is being executed. In such a case, the control unit 110 determines whether or not any one of the access point mode, the relay mode, and the gateway mode is being executed. When an affirmative determination is made in step S502, the process proceeds to step S503, and a negative determination terminates the present routine. Note that when a negative determination is made in step S502, the routine shown in FIG. 8 or FIG. 11 may be executed.

In step S503, the control unit 110 acquires information related to a substituting vehicle 20. The control unit 110 compares the vehicle ID of the own vehicle with the list of substituting vehicles 20 received from the server 30 and stored in the secondary storage unit 103, and extracts the vehicle ID of a vehicle 10 having the highest priority among the substituting vehicles 20.

In step S504, the control unit 110 determines whether or not there is a substituting vehicle 20. For example, when a vehicle ID corresponding to a substituting vehicle 20 is extracted in step S503, it is determined that there is a substituting vehicle 20. The process proceeds to step S505 when an affirmative determination is made in step S504, and proceeds to step S511 when a negative determination is made.

In step S505, the control unit 110 communicates with the substituting vehicle 20 and acquires vehicle information. Here, at least information is acquired with which it can be determined whether or not the substituting vehicle 20 is in the powered-off state. In step S506, the control unit 110 determines whether or not the substituting vehicle 20 is in the powered-off state. Here, a vehicle 10 that is listed as a substituting vehicle 20 but has changed into the powered-on state later cannot serve as a substituting vehicle 20. Accordingly, the control unit 110 determines the state of the substituting vehicle 20 included in the list. The process proceeds to step S507 when an affirmative determination is made in step S506, and returns to step S503 when a negative determination is made. When the process returns to step S503, the control unit 110 acquires information related to a substituting vehicle 20 having the next highest priority among the substituting vehicles 20 included in the list.

In step S507, the control unit 110 transmits a takeover request to the substituting vehicle 20 with which communication is performed in most recent step S505. The takeover request is a request to take over the operation mode. The takeover request includes information related to the operation mode. In step S508, the control unit 110 executes the client mode. Thus, the access point mode, the relay mode, and the gateway mode are ceased.

In step S509, the control unit 110 acquires vehicle information. In step S510, the control unit 110 transmits the vehicle information to the server 30. At the time, a notification of shifting to the client mode, a notification of handing over the operation mode to a substituting vehicle 20, and the vehicle ID of the substituting vehicle 20 may also be included in the vehicle information and transmitted. Thus, the vehicle information DB 32 of the server 30 is updated.

In step S511, the control unit 110 executes the client mode. In step S512, the control unit 110 acquires vehicle information. In step S513, the control unit 110 transmits the vehicle information to the server 30. At the time, a notification of shifting to the client mode and a notification of failing to hand over the operation mode to a substituting vehicle 20 may also be included in the vehicle information and transmitted. Thus, the server 30 decides on again a role of each vehicle 10.

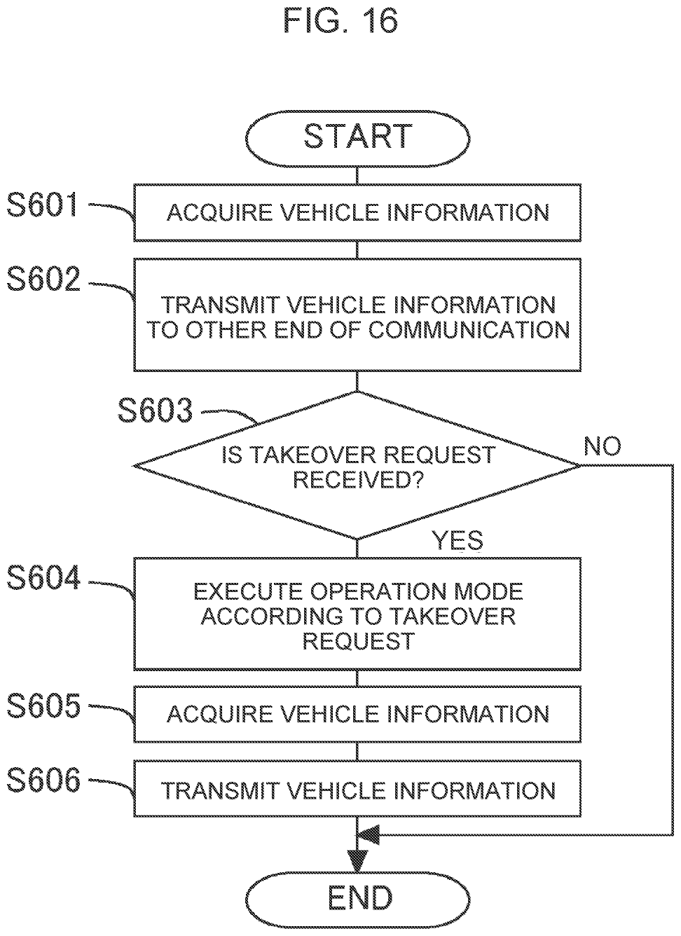

FIG. 16 is a flowchart of a process at each vehicle 10 according to the third embodiment. The process shown in FIG. 16 is executed at a vehicle 10 that has received communication from the vehicle 10 in step S505 described above.

In step S601, the control unit 110 acquires vehicle information. In step S602, the control unit 110 transmits the vehicle information to the vehicle 10 on the other end of the V2V communication N2. The other-end vehicle 10 is the vehicle 10 executing step S505 described above. The then transmitted information may include information with which it can be determined whether or not the state is powered-off.

In step S603, the control unit 110 determines whether or not a takeover request is received. When an affirmative determination is made in step S603, the process proceeds to step S604, and a negative determination terminates the present routine. Note that when the state is already powered-on, the control unit 110 may determine that a takeover request is not received. In step S604, the control unit 110 executes an operation mode according to information related to the operation mode included in the takeover request.

In step S605, the control unit 110 acquires vehicle information. In step S606, the control unit 110 transmits the vehicle information to the server 30. At the time, information related to the operation mode that is being executed is also included in the vehicle information and transmitted.

As described hereinabove, according to the third embodiment, since a substituting vehicle 20 can immediately take over an operation mode even if a vehicle 10 included in the network changes into the powered-on state, communication can be prevented from being interrupted.

### Other Embodiments

The above-described embodiments are only examples, and the present disclosure can be embodied with changes made as appropriate without departing from the gist thereof. The processes and means described in the present disclosure can be freely combined and implemented to the extent that there arises no technical inconsistency. The process described as being executed by a single device may be executed by a plurality of devices in a divided manner. Alternatively, the process described as being executed by different devices may be executed by a single device. In a computer system, it can be flexibly changed what hardware configuration (server configuration) is used to implement each function. For example, a vehicle 10 may include part or the whole of the functionality of the server 30.

The present disclosure can also be implemented by providing a computer with a computer program in which the functions described in the embodiments are packaged, and by one or more processors included in the computer reading and executing the program. Such a computer program may be provided to the computer through a non-transitory computer-readable storage medium that is capable of connecting to a system bus of the computer, or may be provided to the computer via a network. Examples of the non-transitory computer-readable storage medium include any types of disks, such as magnetic disks (Floppy® disk, hard disk drive (HDD), and the like) and optical disks (CD-ROM, DVD disk, Blu-ray Disc, and the like), a read only memory (ROM), a random access memory (RAM), an EPROM, an EEPROM, a magnetic card, a flash memory, an optical card, and any types of media suitable to store electronic instructions.

What is claimed is:

1. An information processing device comprising
a processor configured to decide on one or more access-point vehicles to execute an access point mode, based on vehicle information on each of vehicles parked within a specific area, the access point mode being for providing an access point in a first vehicle network including the vehicles, wherein
the vehicle information includes position information and information related to a range of vehicle-to-vehicle communication, with respect to each vehicle, and
the processor is configured to
decide on the one or more access-point vehicles such that the specific area is covered by the range or ranges of the vehicle-to-vehicle communication by the one or more access-point vehicles,
decide on one or more gateway vehicles to execute a gateway mode among the vehicles parked within the specific area, the gateway mode being for connecting the first vehicle network to a second vehicle network, and
transmit instructions about the access point mode and the gateway mode to the one or more access-point vehicles and the one or more gateway vehicles, respectively.

2. The information processing device according to claim 1, wherein
the vehicle information includes information related to throughput in the second vehicle network, and
the processor is configured to decide on the one or more gateway vehicles such that the throughput in a connection between each vehicle and the second vehicle network via the first vehicle network is a predetermined value or more.

3. The information processing device according to claim 2, wherein the processor is configured to decide on the one or more gateway vehicles such that a number of the gateway vehicles becomes smallest possible.

4. The information processing device according to claim 1, wherein the processor is further configured to
decide on a relay vehicle to execute a relay mode for relaying communication between the access-point vehicles, and
transmit an instruction about the relay mode to the relay vehicle.

5. The information processing device according to claim 1, wherein
the vehicle information includes information related to voltage of a battery of each vehicle, and
the processor is configured to decide on the one or more access-point vehicles and the one or more gateway vehicles among the vehicles excluding a vehicle of which the voltage of the battery is a predetermined voltage or less.

6. The information processing device according to claim 4, wherein
the vehicle information includes information related to voltage of a battery of each vehicle, and
the processor is configured to decide on the relay vehicle among the vehicles excluding a vehicle of which the voltage of the battery is a predetermined voltage or less.

7. The information processing device according to claim 1, wherein the processor is configured to
generate a list including one or more substituting vehicles for each vehicle included in the first vehicle network, and
transmit the list to each vehicle included in the first vehicle network.

8. The information processing device according to claim 7, wherein the list of the substituting vehicles includes information related to order of priorities of the substituting vehicles.

9. A non-transitory storage medium storing instructions that are executable by one or more processors and that cause the one or more processors to perform functions comprising
deciding on one or more access-point vehicles to execute an access point mode, based on vehicle information on each of vehicles parked within a specific area, the access point mode being for providing an access point in a first vehicle network including the vehicles, wherein
the vehicle information includes position information and information related to a range of vehicle-to-vehicle communication, with respect to each vehicle, and
the functions include:
deciding on the one or more access-point vehicles such that the specific area is covered by the range or ranges of the vehicle-to-vehicle communication by the one or more access-point vehicles;
deciding on one or more gateway vehicles to execute a gateway mode among the vehicles parked within the specific area, the gateway mode being for connecting the first vehicle network to a second vehicle network; and
transmitting instructions about the access point mode and the gateway mode to the one or more access-point vehicles and the one or more gateway vehicles, respectively.

10. The non-transitory storage medium according to claim 9, wherein
the vehicle information includes information related to throughput in the second vehicle network, and
the functions include deciding on the one or more gateway vehicles such that the throughput in a connection between each vehicle and the second vehicle network via the first vehicle network is a predetermined value or more.

11. The non-transitory storage medium according to claim 10, wherein the functions include deciding on the one or more gateway vehicles such that a number of the gateway vehicles becomes smallest possible.

12. The non-transitory storage medium according to claim 9, wherein the functions include:
deciding on a relay vehicle to execute a relay mode for relaying communication between the access-point vehicles; and
transmitting an instruction about the relay mode to the relay vehicle.

13. The non-transitory storage medium according to claim 9, wherein
the vehicle information includes information related to voltage of a battery of each vehicle, and
the functions include deciding on the one or more access-point vehicles and the one or more gateway vehicles among the vehicles excluding a vehicle of which the voltage of the battery is a predetermined voltage or less.

14. The non-transitory storage medium according to claim 12, wherein
the vehicle information includes information related to voltage of a battery of each vehicle, and
the functions include deciding on the relay vehicle among the vehicles excluding a vehicle of which the voltage of the battery is a predetermined voltage or less.

15. The non-transitory storage medium according to claim 9, wherein the functions include:
generating a list including one or more substituting vehicles for each vehicle included in the first vehicle network; and
transmitting the list to each vehicle included in the first vehicle network.

16. The non-transitory storage medium according to claim 15, wherein the list of the substituting vehicles includes information related to order of priorities of the substituting vehicles.

17. A system comprising:
vehicles parked within a specific area; and
a server including a processor configured to decide on one or more access-point vehicles to execute an access point mode, based on vehicle information received from each of the vehicles, the access point mode being for providing an access point in a first vehicle network including the vehicles, wherein
the vehicle information includes position information and information related to a range of vehicle-to-vehicle communication, with respect to each vehicle, and
the processor is configured to
decide on the one or more access-point vehicles such that the specific area is covered by the range or ranges of the vehicle-to-vehicle communication by the one or more access-point vehicles,
decide on one or more gateway vehicles to execute a gateway mode among the vehicles parked within the specific area, the gateway mode being for connecting the first vehicle network to a second vehicle network, and
transmit instructions about the access point mode and the gateway mode to the one or more access-point vehicles and the one or more gateway vehicles, respectively.

18. The system according to claim 17, wherein
the vehicle information includes information related to throughput in the second vehicle network, and
the processor is configured to decide on the one or more gateway vehicles such that the throughput in a connection between each vehicle and the second vehicle network via the first vehicle network is a predetermined value or more.

19. The system according to claim 18, wherein the processor is configured to decide on the one or more gateway vehicles such that a number of the gateway vehicles becomes smallest possible.

20. The system according to claim 17, wherein the processor is further configured to
decide on a relay vehicle to execute a relay mode for relaying communication between the access-point vehicles, and
transmit an instruction about the relay mode to the relay vehicle.
